(19) United States
(12) Patent Application Publication
(10) Pub. No.: US 2014/0313141 A1
(43) Pub. Date: Oct. 23, 2014

(54) SMART APPARATUS HAVING TOUCH INPUT MODULE AND ENERGY GENERATING DEVICE, AND OPERATING METHOD OF THE SMART APPARATUS

(71) Applicant: SAMSUNG ELECTRONICS CO., LTD., Suwon-si (KR)

(72) Inventors: Young-jun PARK, Suwon-si (KR); Hyun-jin KIM, Hwaseong-si (KR); Hyuk CHANG, Seongnam-si (KR)

(73) Assignee: SAMSUNG ELECTRONICS CO., LTD., Suwon-si (KR)

(21) Appl. No.: 14/143,606

(22) Filed: Dec. 30, 2013

(30) Foreign Application Priority Data
Apr. 23, 2013 (KR) 10-2013-0044995

(51) Int. Cl. G06F 3/041

(52) U.S. Cl. CPC G06F 3/041
USPC 345/173

(57) ABSTRACT

A smart apparatus and a method of operating the same are provided. The smart apparatus includes a display device in which an application is embedded; a touch input module which is disposed on the display device and is configured to execute the application in response to a touch input applied thereto; and a first energy generating device which is disposed on the display device and is configured to generate electric energy from a mechanical force externally applied thereto.

### CROSS-REFERENCE TO RELATED APPLICATIONS

This application claims priority from Korean Patent Application No. 10-2013-0044995, filed on Apr. 23, 2013, in the Korean Intellectual Property Office, the disclosure of which are incorporated herein in its entirety by reference.

### BACKGROUND

1. Field

Apparatuses and method consistent with exemplary embodiments to smart apparatuses, and more particularly, to smart apparatuses having touch input modules and energy generating devices, and methods of operating the smart apparatuses.

2. Description of the Related Art

Currently, smart apparatuses, such as smart phones, tablet personal computers (PCs), navigation devices, etc., are being widely used. A smart apparatus refers to an apparatus that is capable of executing applications and performing data transmission via a wireless communication network. Generally, such a smart apparatus is configured to execute applications via a touch input device, such as a touch panel. Furthermore, message transmissions and game play via social network services (SNS) using such a smart apparatus have become very popular.

### SUMMARY

One or more exemplary embodiments provide smart apparatuses having touch input modules and energy generating devices, and methods of operating the smart apparatus.

According to an aspect of an exemplary embodiment, there is provided a smart apparatus including a display device, in which an application is embedded; a touch input module which is disposed on the display device and is configured to execute the application in response to a touch input applied thereto; and a first energy generating device which is disposed on the display device and is configured to generate electric energy from a mechanical force externally applied thereto.

The first energy generating device may be flexible and may be configured to transmit light from the display device. The first energy generating device may include at least one of a piezoelectric generator and a triboelectric generator.

The first energy generating device may include first and second substrates which are disposed to be apart from each other; first and second electrodes which are disposed on the first and second substrates, respectively; and a plurality of piezoelectric nanowires disposed between the first and second electrodes.

The smart apparatus may further include a dielectric film disposed between the second electrode and the piezoelectric nanowires.

The first energy generating device may include first and second substrates which are arranged to be apart from each other; first and second electrodes which are disposed on the first and second substrates, respectively; and a piezoelectric thin-film layer disposed between the first and second electrodes.

The first energy generating device may include first and second substrates which are arranged to be apart from each other; first and second electrodes, which are disposed on the first and second substrates, respectively; a first triboelectric layer which is disposed on the first electrode and includes a first dielectric material or a metal; and a second triboelectric layer which is disposed on the second electrode and includes a second dielectric material different from the first dielectric material.

The touch input module may be interposed between the first energy generating device and the display device or the first energy generating device may be interposed between the touch input module and the display device.

The smart apparatus may further include a second energy generating device which is configured to generate electric energy from a mechanical forces externally applied thereto, and is disposed on the display device.

According to an aspect of another exemplary embodiment, there is provided a method of operating at least one smart apparatus, the method including a display device in which an application is embedded; a touch input module which is disposed on the display device and is configured to execute the application in response to a touch input applied thereto; and an energy generating device which is disposed on the display device, the method including generating electric energy by the energy generating device by applying an external mechanical force to the smart apparatus.

The method may further include executing the application embedded in the display device in response to the touch input applied the touch input module; and generating electric energy from the touch input by using the energy generating device.

The method may further include displaying an amount of electric energy generated by the energy generating device on the display device.

The method may further include synchronizing the amount of electric energy displayed on the display device to a game score displayed as the application is executed.

The method may further include executing applications by a plurality of smart apparatuses connected via a wireless communication network in response to touch inputs applied to touch input modules of the smart apparatuses; generating electric energy by energy generating devices of the smart apparatuses from the touch inputs; and displaying on the display devices of the smart apparatuses amounts of electric energy generated by the energy generating devices.

The method may further include synchronizing the amounts of electric energy displayed on the display devices to game scores displayed as the applications are executed.

The method may further include determining an energy harvesting rankings based on the amounts of electric energy displayed on the display devices.

The method may further include storing or transmitting electric energy generated by the energy generating devices.

According to an aspect of another exemplary embodiment, there is provided a smart apparatus including a main body including a display device; and a cover case which is configured to cover the main body and includes an energy generating device configured to generate electric energy from a mechanical force externally applied thereto.

The cover case may further include an energy storage device which is configured to store electric energy generated by the energy generating device.

### BRIEF DESCRIPTION OF THE DRAWINGS

The above and/or other aspects will become apparent and more readily appreciated from the following description of exemplary embodiments, taken in conjunction with the accompanying drawings of which:

FIG. 1 is a perspective view of a smart apparatus according to an exemplary embodiment;

FIG. 2 is a sectional view of the smart apparatus shown in FIG. 1;

FIG. 3 is a sectional view of an example of an energy generating device shown in FIG. 2;

FIG. 4 is a sectional view of another example of the energy generating device shown in FIG. 2;

FIG. 5 is a sectional view of another example of the energy generating device shown in FIG. 2;

FIG. 6 is a sectional view of another example of the energy generating device shown in FIG. 2;

FIG. 7 is a sectional view of another example of the energy generating device shown in FIG. 2;

FIG. 8 shows that two users are executing an SNS game application on smart apparatuses via a wireless communication network;

FIG. 9 is a flowchart showing operations of each of the smart apparatuses shown in FIG. 8;

FIG. 10 is a sectional view of a smart apparatus according to another exemplary embodiment;

FIG. 11 is a sectional view of a smart apparatus according to another exemplary embodiment;

FIG. 12 is a perspective view of a smart apparatus according to another exemplary embodiment;

FIG. 13 is a plan view showing that a cover case of the smart apparatus is open; and

FIG. 14 is a sectional view of the smart apparatus shown in FIG. 3.

### DETAILED DESCRIPTION

Reference will now be made in detail to embodiments, examples of which are illustrated in the accompanying drawings. In this regard, the present exemplary embodiments may have different forms and should not be construed as being limited to the descriptions set forth herein. Accordingly, the exemplary embodiments are described below, by referring to the figures, to explain aspects of the present description. Expressions such as “at least one of,” when preceding a list of elements, modify the entire list of elements and do not modify the individual elements of the list.

In the drawings, the thicknesses of layers and regions are exaggerated for clarity. It will also be understood that when a layer is referred to as being “on” another layer or substrate, it can be directly on the other layer or substrate, or intervening layers may also be present. Like reference numerals in the drawings denote like elements, and thus their repeated description may be omitted.

Smart apparatuses according to exemplary embodiments refer to apparatuses capable of executing applications and performing data transmission via wireless communication networks. Examples of the smart apparatuses include a smart phone, a tablet personal computer (PC), a navigation device, etc. Furthermore, the smart apparatus may execute a message application and/or a game based on a social network service (SNS) via a wireless communication network.

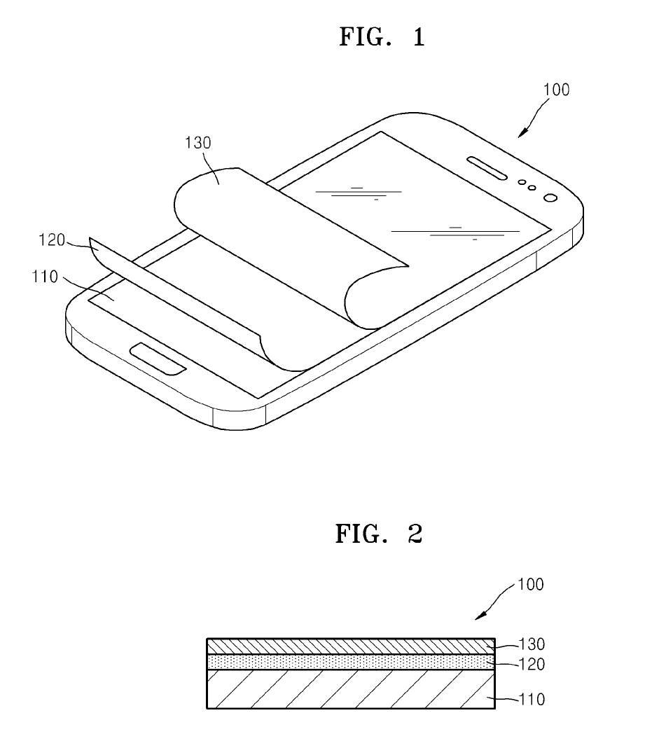

FIG. 1 is a perspective view of a smart apparatus 100 according to an exemplary embodiment. FIG. 2 is a sectional view of the smart apparatus 100 shown in FIG. 1.

Referring to FIGS. 1 and 2, the smart apparatus 100 may include a display device 110, a touch input module 120 disposed on the display device 110, and an energy generating device 130 disposed on the touch input module 120. For example, the display device 110 may be a liquid crystal display (LCD), an organic light emitting device, etc. Various applications (e.g., message applications, game applications, etc.) may be embedded in the display device 110.

The touch input module 120 is a module disposed on top of the display device 110 and capable of executing applications designated by touches and may include a touch screen or a touch panel, for example. Furthermore, the energy generating device 130 generates electric energy by using mechanical force externally applied to the smart apparatus 100. In detail, when a mechanical force from a touch on the touch input module 120 or a mechanical force due to pressure, deformation, distortion, bending, vibration, or sound applied from outside is applied to the energy generating device 130, the energy generating device 130 may generate electric energy by using such mechanical force. As described below, by a touch on the touch input module 120, a predetermined application may be executed and the energy generating device 130 may generate electric energy.

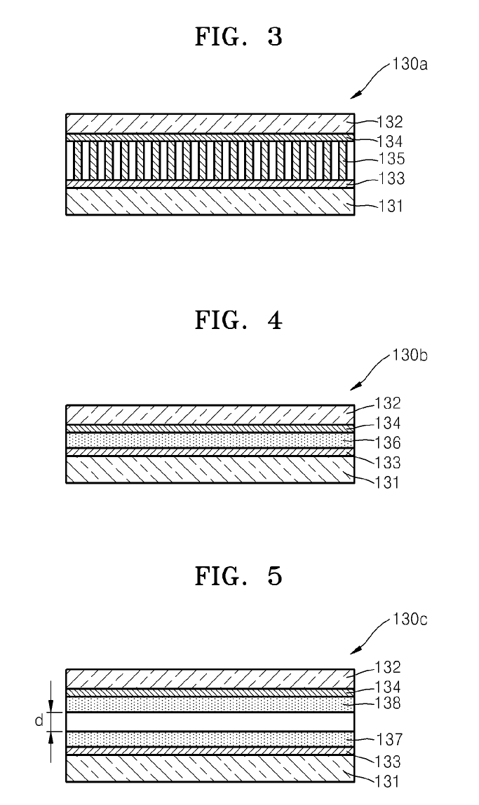

The energy generating device 130 is flexible and may be phototransmissive for transmitting light emitted by the display device 110. Furthermore, the energy generating device 130 may have a relatively small thickness equal to or below about 1 mm. However, the inventive concept is not limited thereto. The energy generating device 130 may include at least one of a piezoelectric generator and a triboelectric generator. The piezoelectric generator may generate electric energy when a piezoelectric material is deformed by a mechanical force due to a touch to the touch input module 120 or a mechanical force applied from outside, such as pressure, deformation, distortion, bending, vibration, or sound. The triboelectric generator may generate electric energy when friction is formed between two layers formed of different materials by an external mechanical force or a distance between two layers is changed by an external mechanical force. FIGS. 3 through 7 shows detailed examples of the energy generating device 130 shown in FIG. 2. A pressure applied to the energy generating device 130 by a finger of a user may generally be from about 1 kPa to about 30 kPa. However, the inventive concept is not limited thereto.

In the smart apparatus 100 having the structure as described above, the display device 110, each of the touch input module 120, and the energy generating device 130 may be flexible, thereby embodying the flexible smart apparatus 100. However, the inventive concept is not limited thereto, and the display device 110 may not have flexibility.

FIG. 3 is a sectional view of an example of the energy generating device 130 shown in FIG. 2. FIG. 3 shows an energy generating device 130a including a piezoelectric generator.

Referring to FIG. 3, the energy generating device 130a includes first and second substrates 131 and 132 that are arranged apart from each other, first and second electrodes 133 and 134 that are disposed on the first and second substrates 131 and 132, and a plurality of piezoelectric nanowires 135 that are disposed between the first and second electrodes 133 and 134. The first and second substrates 131 and 132 may include a transparent and flexible material. For example, the first and second substrates 131 and 132 may include plastics, textiles, fibers, thin wafers, or metal foils. However, the inventive concept is not limited thereto, and the first and second substrates 131 and 132 may include a hard material, such as a glass.

The first electrode 133 is disposed on the top surface of the first substrate 131 and the second electrode 134 is disposed on the bottom surface of the second substrate 132. Here, the first and second electrodes 133 and 134 may include flexible and transparent conductive materials. For example, the first and second electrodes 133 and 134 may include graphene, carbon nanotubes (CNTs), indium tin oxide (ITO), a metal, or a conductive polymer. However, the inventive concept is not limited thereto. Here, for example, the metal may include Ag, Al, Cu, Au, etc.

The plurality of piezoelectric nanowires 135 are disposed on the top surface of the first electrode 133. Here, the piezoelectric nanowires 135 may be arranged to be perpendicular to or tilted at a predetermined angle with respect to the first electrode 133. Although not shown, an insulation layer having a high insulation constant may be further provided on the top surface of the first electrode 133 for uniformly growing the piezoelectric nanowires 135. The second electrode 134 is disposed on the piezoelectric nanowires 135. The piezoelectric nanowires 135 may be deformed by a mechanical force from a touch on the touch input module 120 or a mechanical force due to pressure, deformation, distortion, bending, vibration, or sound applied from outside. In this case, piezoelectric potentials may be formed at two opposite ends of the piezoelectric nanowires 135, and electric energy may be generated thereby. For example, the piezoelectric nanowires 135 may include ZnO, SnO, ZnSnO₃, or polyvinylidene fluoride (PVDF). However, the inventive concept is not limited thereto. FIG. 3 shows a case in which the energy generating device 130a includes one piezoelectric generator. However, the energy generating device 130a may have a structure in which a plurality of piezoelectric generators are stacked.

FIG. 4 is a sectional view of another example of the energy generating device 130 shown in FIG. 2. FIG. 4 shows an energy generating device 130b including a piezoelectric generator.

Referring to FIG. 4, the energy generating device 130b includes the first and second substrates 131 and 132 arranged to be apart from each other, the first and second electrodes 133 and 134 disposed on the first and second substrates 131 and 132, and a piezoelectric thin-film layer 136 interposed between the first electrode 133 and the second electrode 134. The first and second substrates 131 and 132 may include a transparent and flexible material. The first electrode 133 is disposed on the top surface of the first substrate 131 and the second electrode 134 is disposed on the bottom surface of the second substrate 132. The first and second electrodes 133 and 134 may include flexible and transparent conductive materials. Since the first and second substrates 131 and 132 and the first and second electrodes 133 and 134 are described above, detailed descriptions thereof will be omitted.

The piezoelectric thin-film layer 136 is disposed between the first electrode 133 and the second electrode 134. The piezoelectric thin-film layer 136 may be deformed by a mechanical force from a touch on the touch input module 120 or a mechanical force due to pressure, deformation, distortion, bending, vibration, or sound applied from outside. In this case, piezoelectric potentials may be formed at upper and lower portions of the piezoelectric thin-film layer 136, and electric energy may be generated thereby. The piezoelectric thin-film layer 136 may include an inorganic material or an organic material. For example, the piezoelectric thin-film layer 136 may include ZnO, SnO, ZnSnO₃, SnO, BaTiO₃, NaNbO₃, PZT, or PVDF. However, the inventive concept is not limited thereto. FIG. 4 shows a case in which the energy generating device 130b includes one piezoelectric generator. However, the energy generating device 130b may have a structure in which a plurality of piezoelectric generators are stacked.

FIG. 5 is a sectional view of another example of the energy generating device 130 shown in FIG. 2. FIG. 5 shows an energy generating device 130c including a triboelectric generator.

Referring to FIG. 5, the energy generating device 130c includes the first and second substrates 131 and 132 that are arranged to be apart from each other, the first and second electrodes 133 and 134 disposed on the first and second substrates 131 and 132, a first triboelectric layer 137 disposed on the first electrode 133, and a second triboelectric layer 138 disposed on the second electrode 134. The first and second substrates 131 and 132 may include a transparent and flexible material. For example, the first and second substrates 131 and 132 may include plastics, textiles, fibers, thin wafers, or metal foils. However, the above-stated materials are merely examples, and the first and second substrates 131 and 132 may include any of various other materials. The first electrode 133 is disposed on the top surface of the first substrate 131 and the second electrode 134 is disposed on the bottom surface of the second substrate 132. Here, the first and second electrodes 133 and 134 may include flexible and transparent conductive materials. For example, the first and second electrodes 133 and 134 may include graphene, carbon nanotube (CNT), indium tin oxide (ITO), a metal, or a conductive polymer. However, the inventive concept is not limited thereto.

The first triboelectric layer 137 is disposed on the top surface of the first electrode 133. Here, the first triboelectric layer 137 may include a first dielectric material or a metal. The second triboelectric layer 138 is disposed on the bottom surface of the second electrode 134. The second triboelectric layer 138 may include a second dielectric material, which is different from the first dielectric material. In detail, the first triboelectric layer 137 may include a material that is easily charged to positive (+) polarity, e.g., polyformaldehyde, etylcellulose, polyamide, wool, silk, Al, paper, cotton, steel, wood, Ni, Cu, Ag, or PVA. The second triboelectric layer 138 may include a material that is easily charged to negative (−) polarity, e.g., silicon rubber, Teflon, polydimethylsiloxane (PDMS), Kapton, polypropylene, polyethylene, or PVC. However, the inventive concept is not limited thereto. For example, the first triboelectric layer 137 may include a material that is easily charged to negative (−) polarity, whereas the second triboelectric layer 138 may include a material that is easily charged to positive (+) polarity. Furthermore, the first and the second triboelectric layers 137,138 may include materials having a relatively significant charging difference. Here, the first triboelectric layer 137 and the second triboelectric layer 138 are charged by contacting each other due to external pressure and then are arranged to be apart from each other by a predetermined distance d. The distance d between the first triboelectric layer 137 and the second triboelectric layer 138 may be changed or friction may be formed between the first triboelectric layer 137 and the second triboelectric layer 138 by a mechanical force due to a touch to the touch input module 120 or a mechanical force applied from outside, such as pressure, deformation, distortion, bending, vibration, or sound. In this case, a difference of charge densities is formed between the first triboelectric layer 137 and the second triboelectric layer 138, and thus electric energy may be generated. FIG. 5 shows a case in which the energy generating device 130c includes a single triboelectric generator. However, the energy generating device 130c may also have a structure in which a plurality of triboelectric generators are stacked.

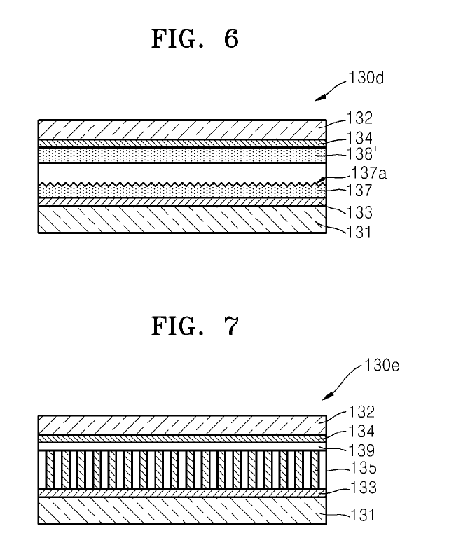

FIG. 6 is a sectional view of another example of the energy generating device 130 shown in FIG. 2. FIG. 6 shows an energy generating device 130d including a triboelectric generator.

Referring to FIG. 6, the energy generating device 130d includes the first and second substrates 131 and 132 that are arranged to be apart from each other, the first and second electrodes 133 and 134 disposed on the first and second substrates 131 and 132, a first triboelectric layer 137′ disposed on the first electrode 133, and a second triboelectric layer 138′ disposed on the second electrode 134. The first and second substrates 131 and 132 may include a transparent and flexible material. The first electrode 133 is disposed on the top surface of the first substrate 131 and the second electrode 134 is disposed on the bottom surface of the second substrate 132. Here, the first and second electrodes 133 and 134 may include flexible and transparent conductive materials. Since the first and second substrates 131 and 132 and the first and second electrodes 133 and 134 are described above, detailed descriptions thereof will be omitted.

The first triboelectric layer 137′ including a first dielectric material or a metal is disposed on the top surface of the first electrode 133. The second triboelectric layer 138′ including a second dielectric material different from the first dielectric material is disposed on the bottom surface of the second electrode 134. Here, the first triboelectric layer 137′ may include nanostructures 137′a, such as nano-pyramids or nanowires. The nanostructures 137′a may react to subtle pressure, may increase an area of the interface between dielectric materials at which a friction is formed, and may control a difference of charge densities. Although FIG. 6 shows a case in which only the first triboelectric layer 137′ includes the nanostructures 137′a, the inventive concept is not limited thereto. For example, both the first triboelectric layer 137′ and the second triboelectric layer 138′ may include nanostructures. Alternatively, only the second triboelectric layer 138′ may include nanostructure. FIG. 6 shows a case in which the energy generating device 130d includes a single triboelectric generator. However, the energy generating device 130d may also have a structure in which a plurality of triboelectric generators are stacked.

FIG. 7 is a sectional view of another example of the energy generating device 130 shown in FIG. 2. FIG. 7 shows an energy generating device 130e including a hybrid generator, which is a combination of a piezoelectric generator and a triboelectric generator.

Referring to FIG. 7, the energy generating device 130e includes the first and second substrates 131 and 132 that are arranged to be apart from each other, the first and second electrodes 133 and 134 disposed on the first and second substrates 131 and 132, the plurality of piezoelectric nanowires 135 disposed between the first electrode 133 and the second electrode 134, and a dielectric film 139 disposed between the piezoelectric nanowires 135 and the second electrode 134. The first and second substrates 131 and 132 may include a transparent and flexible material. The first electrode 133 is disposed on the top surface of the first substrate 131 and the second electrode 134 is disposed on the bottom surface of the second substrate 132. Here, the first and second electrodes 133 and 134 may include flexible and transparent conductive materials. Since the first and second substrates 131 and 132 and the first and second electrodes 133 and 134 are described above, detailed descriptions thereof will be omitted.

The plurality of piezoelectric nanowires 135 are disposed on the top surface of the first electrode 133. Here, the piezoelectric nanowires 135 may be arranged to be perpendicular to or tilted at a predetermined angle tilted with respect to the first electrode 133. Although not shown, an insulation layer having a high insulation constant may be further disposed on the top surface of the first electrode 133 for uniformly growing the piezoelectric nanowires 135. The piezoelectric nanowires 135 may include a material at two opposite ends of which piezoelectric potentials are formed as the material is deformed, e.g., ZnO, SnO, ZnSnO₃, or polyvinylidene fluoride (PVDF). However, the inventive concept is not limited thereto. Furthermore, the dielectric film 139 is arranged between the piezoelectric nanowires 135 and the second electrode 134. The dielectric film 139 insulates the first electrode 133 and the second electrode 134 from each other and generates electric energy based on a difference of charge densities that is formed along with a change of a distance between the dielectric film 139 and the first electrode 133. The dielectric film 139 may include an inorganic material or a polymer-based organic material. For example, the dielectric film 139 may include silicon rubber, Teflon, PDMS, PVD, Kapton, polypropylene, polyethylene, PVC, polyformaldehyde, etylcellulose, polyamide, wool, silk, or PVA.

In the structure as described above, when an external mechanical force is applied to the energy generating device 130e, electric energy may be generated as the piezoelectric nanowires 135 are deformed, and electric energy may also be generated as a distance between the dielectric film 139 and the first electrode 133 is changed. FIG. 7 shows a case in which the energy generating device 130e includes a single hybrid generator. However, the energy generating device 130e may also have a structure in which a plurality of hybrid generators are stacked. The energy generating device 130 shown in FIG. 2 may have a structure in which at least two from among the piezoelectric generator, the triboelectric generator, and the hybrid generator shown in FIGS. 3 through 7 are stacked.

In the smart apparatus 100 shown in FIG. 1, when an external mechanical force (e.g., a pressure that a finger of a user presses the energy generating device 130) is applied to the energy generating device 130, the energy generating device 130 generates electric energy. The electric energy may be charged to a battery of the smart apparatus 100 or stored in a separate storage device via an AD converter (not shown) and a control unit (not shown). An amount of electric energy generated by the energy generating device 130 may be quantized and displayed on the display device 110.

When the touch input module 120 is touched, the smart apparatus 100 may execute applications (e.g., message applications, game applications, etc.) and generate electric energy from a pressure that the touch on the touch input module 120 applies to the energy generating device 130, simultaneously. Here, an amount of electric energy generated while an application is being launched may be displayed on the display device 110 in real time. Furthermore, an amount of electric energy generated by the energy generating device 130 may be synchronized with execution of an application. For example, when a user executes a game application by touching the touch input module 120, an amount of electric energy generated by the energy generating device 130 may be synchronized with a game score displayed as the game application is executed. In this case, an energy harvesting score, which indicates an amount of generated electric energy, and a game score may be displayed together on the display device 110.

The smart apparatus 100 may transmit data via a wireless communication network. Therefore, the plurality of smart apparatuses 100 may be used to execute SNS applications (e.g., SNS message applications, SNS game applications, etc.) using a wireless communication network. Here, when users of the smart apparatuses 100 touch the touch input modules 120 and execute an SNS application, electric energies are generated from the energy generating devices 130, and the electric energy may be charged to batteries of the smart apparatuses 100 or stored in separate storage devices. Furthermore, amounts of electric energies generated by the energy generating devices 130 may be synchronized with execution of an application. For example, when the plurality of users execute an SNS game application by using the smart apparatuses 100, amounts of electric energies generated by the energy generating devices 130 may be synchronized with game scores. In other words, when the users execute an SNS game application via a wireless communication network, game scores acquired by playing the SNS game application and energy harvesting scores, which indicate amounts of electric energies generated as the touch input modules 120 are touched, may be displayed together. Therefore, an energy harvesting rankings indicating which of the users harvested the largest amount of energy may be determined based on the energy harvesting scores displayed on the smart apparatuses 100. Electric energies generated by the smart apparatuses 100 as described above may be transmitted via a wireless communication network.

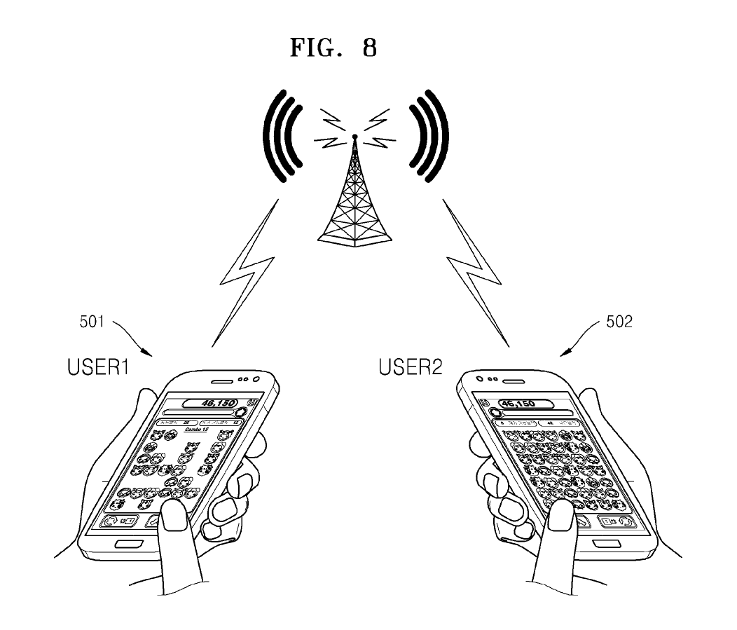

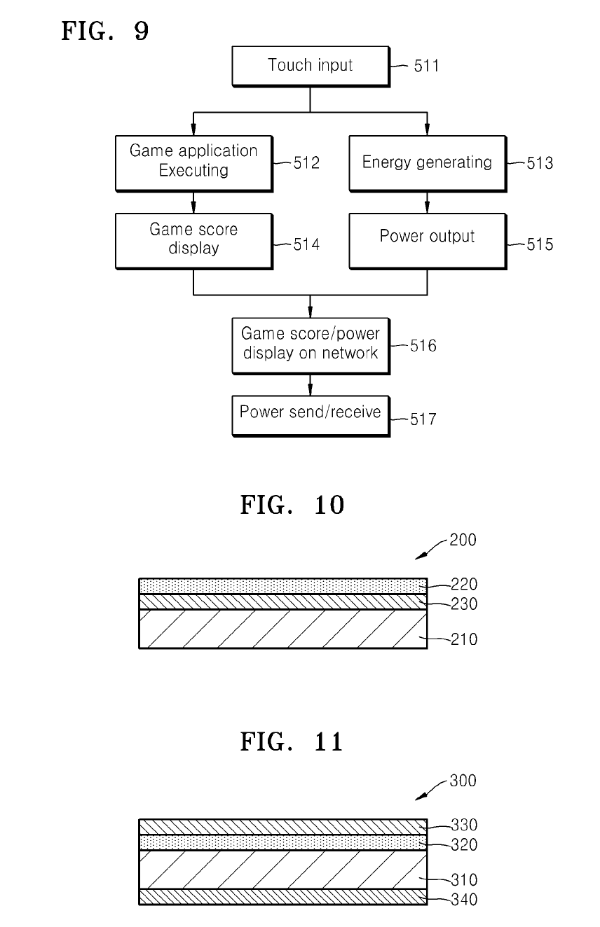

FIG. 8 shows that two users are executing an SNS game application on smart apparatuses 501 and 502 via a wireless communication network. FIG. 9 is a flowchart showing operations of each of the smart apparatuses 501 and 502 shown in FIG. 8.

Referring to FIG. 8, two users are executing an SNS game application on the smart apparatuses 501 and 502 via a wireless communication network. Here, operations of the smart apparatuses 501 and 502 will be described below with reference to FIG. 9. First, touch input panels (120 of FIG. 1) of the smart apparatuses 501 and 502 are touched (operation 511). As a result, an SNS game application embedded in display devices (110 of FIG. 1) of the smart apparatuses 501 and 502 is executed (operation 512). At the same time, energy generating devices (130 of FIG. 1) of the smart apparatuses 501 and 502 generate electric energies by using mechanical forces due to the touches on the touch input panels 120 (operation 513). As game is being played, game scores are displayed on the display devices 110 (operation 514), and the electric energies generated by the energy generating device 130 are output (operation 515). Next, game scores acquired by the two users by playing games and amounts of electric energies generated as the two users touch the smart apparatuses 501 and 502 are displayed together on the display devices 110 of the smart apparatuses 501 and 502 via a wireless communication network (operation 516). Here, not only a game score rankings, but also energy harvesting rankings indicating which of the two users has generated more electric energy may be determined. The electric energies generated at the smart apparatuses 501 and 502 may be either transmitted by a user to the other user or a third party user or received by the user from the other user or a third party user, via a wireless communication network (operation 517.

FIG. 10 is a sectional view of a smart apparatus 200 according to another exemplary embodiment.

Referring to FIG. 10, the smart apparatus 200 includes a display device 210 in which applications are embedded, an energy generating device 230 disposed on the top surface of the display device 110, and a touch input module 220 disposed on the top surface of the energy generating device 230. Here, since the descriptions of the display device 210, the touch input module 220, and the energy generating device 230 are given above with reference to FIG. 1, detailed descriptions thereof will be omitted. While the smart apparatus 100 shown in FIG. 1 has a structure in which the display device 110, the touch input module 120, and the energy generating device 130 are stacked in the order stated, the smart apparatus 200 according to the present exemplary embodiment has a structure in which the display device 210, the energy generating device 230, and the touch input module 220 are stacked in the order stated. In the structure as described above, when the touch input module 220 is touched, an application embedded in the display device is executed, and, at the same time, a mechanical force generated from the touch on the touch input module is applied to the energy generating device. As a result, electric energy may be generated. The generated electric energy may be charged to a battery of the smart apparatus 200 or stored in a separate storage device. Operations of a smart apparatus shown in FIG. 10 is identical to those of the smart apparatus 100 shown in FIG. 1.

FIG. 11 is a sectional view of a smart apparatus 300 according to another exemplary embodiment. The smart apparatus 300 shown in FIG. 11 is identical to the smart apparatus 100 shown in FIG. 1, except that a second energy generating device 340 is disposed on the bottom surface of a display device 310.

Referring to FIG. 11, the smart apparatus 300 includes a display device 310, a touch input module 320 disposed on the top surface of the display device 310, a first energy generating device 330 disposed on the top surface of the touch input module 320, and the second energy generating device 340 disposed on the bottom surface of the display device 310. The display device 310 may embed therein various applications (e.g., message applications, game applications, etc.). The touch input module 320 is a module which is disposed on the top surface of the display device 310 and is capable of executing a desired application based on a touch, e.g., a touch screen or a touch panel.

The first energy generating device 330 is disposed on the top surface of the touch input module 320 and generates electric energy by using a mechanical force externally applied to the smart apparatus 300. In detail, when a mechanical force from a touch on the touch input module 320 or a mechanical force due to pressure, deformation, distortion, bending, vibration, or sound applied from outside is applied to the first energy generating device 330, the first energy generating device 330 may generate electric energy by using such mechanical forces. By a touch on the touch input module 320, a predetermined application may be executed and the first energy generating device 330 may generate electric energy. The first energy generating device 330 may be flexible and transmissive for transmitting light emitted by the display device 310. The first energy generating device 330 may include at least one of a piezoelectric generator and a triboelectric generator. The first energy generating device 330 is identical to the energy generating device 130 shown in FIG. 1. As shown in FIG. 10, the first energy generating device 330 and the touch input module 320 may be stacked on the display device 310 in the order stated.

The second energy generating device 340 is disposed on the bottom surface of the display device 310 and generates electric energy by using a mechanical force applied to the smart apparatus 300. In detail, when a mechanical force due to pressure, deformation, distortion, bending, vibration, or sound applied from outside is applied to the second energy generating device 340, the second energy generating device 340 may generate electric energy by using such mechanical forces. Since the second energy generating device 340 is disposed on the bottom surface of the display device 310, it is not necessary for the second energy generating device 340 to be transparent, unlike the first energy generating device 330.

Operations of the smart apparatus 300 according to the present exemplary embodiment are identical to those of the smart apparatus 100 shown in FIG. 1, except that additional electric energy may be generated by the second energy generating device 340. In the smart apparatus 300 having the structure as described above, each of the display device 310, the touch input module 320, the first energy generating device 330, and the second energy generating device 340 may have flexibility, thereby embodying the flexible smart apparatus 300. However, the inventive concept is not limited thereto, and the display device 310 may not have flexibility.

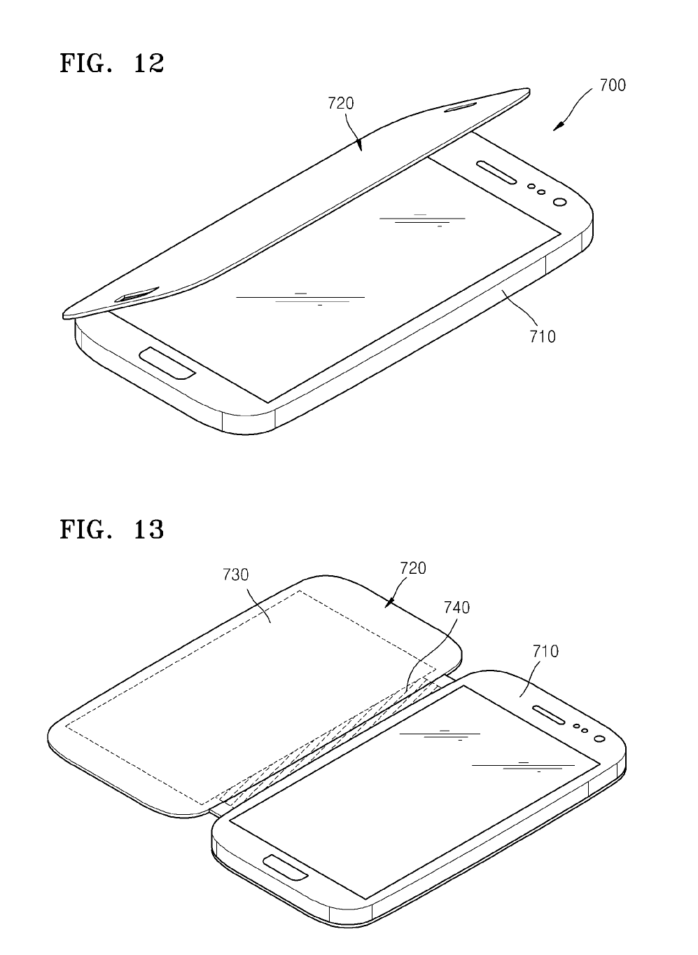

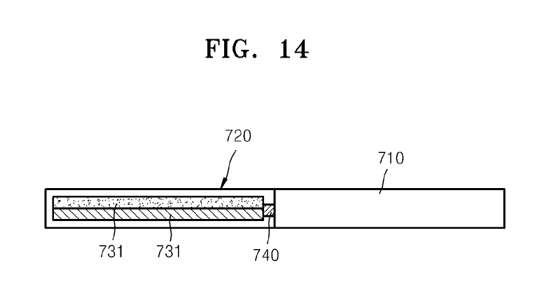

FIG. 12 is a perspective view of a smart apparatus 700 according to another exemplary embodiment. FIG. 13 is a plan view showing that a cover case 720 of the smart apparatus 700 is open. FIG. 14 is a sectional view of the smart apparatus 700 shown in FIG. 3.

Referring to FIGS. 12 through 14, the smart apparatus 700 includes a main body 710, which includes a display device, and the cover case 720, which is connected to the main body 710 and covers and protects the main body 710. Various applications may be embedded in the display device. The smart apparatus 700 may further include a touch input module, which is arranged on the display device and is capable of executing applications based on touches. Furthermore, the main body 710 may further include an energy generating device, which generates electric energy by using mechanical forces from the touch input module and from outside, as shown in FIGS. 1, 10, and 11.

The cover case 720 may include a flip type case which may cover or expose a display screen of the display device. According to the present exemplary embodiment, the cover case 720 includes an energy generating device 730, which generates electric energy. The energy generating device 730 may generate electric energy by using mechanical forces externally applied to the smart apparatus 700. In detail, when a mechanical force due to pressure, deformation, distortion, bending, vibration, or sound applied from outside is applied to the smart apparatus 700, the energy generating device 730 may generate electric energy by using the mechanical force. The energy generating device 730 is identical to the energy generating device 130 as shown in FIG. 1 and may include at least one of a piezoelectric generator and a triboelectric generator. Exemplary embodiments of the energy generating device 730 are shown in FIGS. 3 through 7. In the present exemplary embodiment, it is not necessary for the energy generating device 730 to be transparent.

The cover case 720 may further include an energy storage device 731 which stores electric energy generated by the energy generating device 730. FIG. 14 shows an example in which the energy storage device 731 is disposed on the bottom surface of the energy generating device 730. Furthermore, the cover case 720 may further include an analog-to-digital (AD) converter (not shown) and a control unit (not shown) for converting and controlling electric energy generated by the energy generating device 730 and storing the electric energy in the energy storage device 731. Furthermore, the cover case 720 may further include a connection circuit 740, which is arranged between the energy generating device 730 and the main body 710 and supplies electric energy generated by the energy generating device 730 to the main body 710. Here, the electric energy generated by the energy generating device 730 may be either directly supplied to the main body 710 via the connection circuit 740 or stored in the energy storage device 731 first and supplied to the main body 710 via the connection circuit 740.

According to the present exemplary embodiment, when a mechanical force is applied to the smart apparatus 700 by a user, the energy generating device 730 included in the cover case 720 may generate electric energy by using the mechanical force. The generated electric energy may be charged to a battery of the main body 710 or may be stored in the energy storage device 731. Furthermore, if the main body 710 of the smart apparatus 700 includes the smart apparatus 100, 200, or 300 shown in FIG. 1, 10, or 11, electric energy may be generated by using a mechanical force applied to the main body 710.

As described above, according to the one or more of the above embodiments, applications may be executed, and, at the same time, electric energy may be generated by a mechanical force applied to an energy generating device, by touching the touch input module. Furthermore, if a plurality of users execute an SNS game application, amounts of electric energies generated by smart apparatuses may be synchronized with game scores. Therefore, an energy harvesting rankings indicating a user who harvested the largest amount of energy may be determined based on energy harvesting scores displayed on smart apparatuses. Furthermore, a smart apparatus may include a cover case including an energy generating device, and thus electric energy may be generated by using mechanical forces applied to the cover case.

It should be understood that the exemplary embodiments described therein should be considered in a descriptive sense only and not for purposes of limitation. Descriptions of features or aspects within each embodiment should typically be considered as available for other similar features or aspects in other embodiments.

What is claimed is:

1. A smart apparatus comprising:
a display device in which an application is embedded;
a touch input module which is disposed on the display device and is configured to execute the application in response to a touch input applied thereto; and
a first energy generating device which is disposed on the display device and is configured to generate electric energy from a mechanical force externally applied thereto.

2. The smart apparatus of claim 1, wherein the first energy generating device is flexible and is configured to transmit light emitted from the display device.

3. The smart apparatus of claim 1, wherein the first energy generating device comprises at least one of a piezoelectric generator and a triboelectric generator.

4. The smart apparatus of claim 3, wherein the first energy generating device comprises:
first and second substrates which are arranged to be apart from each other;
a first electrode which is disposed on the first substrate;
a second electrode which is disposed on the second substrate; and
a plurality of piezoelectric nanowires interposed between the first and second electrodes.

5. The smart apparatus of claim 3, further comprising a dielectric film interposed between the second electrode and the piezoelectric nanowires.

6. The smart apparatus of claim 2, wherein the first energy generating device comprises:
first and second substrates which are arranged to be apart from each other;
a first electrode which is disposed on the first substrate;
a second electrodes which is disposed on the second substrate; and
a piezoelectric thin-film layer interposed between the first and second electrodes.

7. The smart apparatus of claim 2, wherein the first energy generating device comprises:
first and second substrates which are arranged to be apart from each other;
a first electrode which is disposed on the first substrate;
a second electrode which is disposed on the second substrate;
a first triboelectric layer which is disposed on the first electrode and comprises a first dielectric material or a metal; and
a second triboelectric layer which is disposed on the second electrode and comprises a second dielectric material different from the first dielectric material.

8. The smart apparatus of claim 1, where the touch input module is interposed between the first energy generating device, the display device or the first energy generating device is interposed between the touch input module and the display device.

9. The smart apparatus of claim 8, further comprising a second energy generating device which is disposed on the display device and configured to generate electric energy from a mechanical force externally applied thereto.

10. A method of operating at least one smart apparatus, which includes a display device in which an applications is embedded; a touch input module which is disposed on the display device and is configured to executes the application in response to a touch input applied thereto; and an energy generating device which is disposed on the display device, the method comprising generating electric energy by the energy generating device by applying an external mechanical force to the smart apparatus.

11. The method of claim 10, further comprising:
executing the application embedded in the display device in response to the touch input applied to the touch input module; and
generating electric energy from the touch input by using the energy generating device.

12. The method of claim 11, further comprising displaying an amount of electric energy generated by the energy generating device on the display device.

13. The method of claim 12, further comprising synchronizing the amount of electric energy displayed on the display device to a game score displayed by the display device as the application is executed.

14. The method of claim 10, further comprising:
executing applications by a plurality of smart apparatuses connected via a wireless communication network in response to touch inputs applied to touch input modules of the smart apparatuses;
generating electric energy by energy generating devices of the smart apparatuses from the touch inputs; and
displaying on the display devices of the smart apparatuses amounts of electric energy generated by the energy generating devices.

15. The method of claim 14, further comprising synchronizing the amounts of electric energy displayed on the display devices to game scores displayed as the applications are executed.

16. The method of claim 15, further comprising determining energy harvesting rankings based on the amounts of electric energy displayed on the display devices.

17. The method of claim 14, further comprising storing or transmitting electric energy generated by the energy generating devices.

18. A smart apparatus comprising:
a main body comprising a display device; and
a cover case which is configured to cover the main body and comprises an energy generating device configured to generate electric energy from a mechanical force externally applied thereto.

19. The smart apparatus of claim 18, wherein the cover case further comprises an energy storage device which is configured to store the electric energy generated by the energy generating device.

20. The smart apparatus of claim 18, wherein the cover case further comprises a connection circuit which is arranged between the energy generating device and the main body and is configured to supply the electric energy generated by the energy generating device to the main body.
